(19) United States
(12) Patent Application Publication
(10) Pub. No.: US 2009/0316384 A1
(43) Pub. Date: Dec. 24, 2009

(54) LIGHT-EMITTING DEVICE AND ILLUMINATION APPARATUS USING THE SAME

(75) Inventors: Yoshihiko Kanayama, Hyogo (JP); Tetsushi Tamura, Osaka (JP); Kenji Ueda, Nara (JP)

Correspondence Address: HAMRE, SCHUMANN, MUELLER & LARSON P.C., P.O. BOX 2902-0902, MINNEAPOLIS, MN, 55402, US

(73) Assignee: PANASONIC CORPORATION, Kadoma-shi, Osaka (JP)

(21) Appl. No.: 12/518,566

(22) PCT Filed: Jan. 11, 2008
(86) PCT No.: PCT/JP2008/050656

§ 371 Date: Jun. 10, 2009

(30) Foreign Application Priority Data
Jan. 12, 2007 (JP) 2007-004979

(51) Int. Cl. F21V 9/16; F21V 7/00

(52) U.S. Cl. 362/84; 362/296.01; 362/307

(57) ABSTRACT

A light-emitting device (1) includes: a base (11); a light-emitting element (12) that is disposed on one principal surface (11a) of the base (11); and a light distribution control reflector (14) that is disposed so as to surround the light-emitting element (12). The light distribution control reflector (14) is at least part of a substantial paraboloid of revolution, and a substantial paraboloid-of-revolution surface (14a) that constitutes an inner surface of the light distribution control reflector (14) is a light-reflecting surface for collecting light emitted from the light-emitting element (12). The light-emitting element (12) is disposed at a position of a substantial focal point of the substantial paraboloid-of-revolution surface (14a), and a normal (N) to the one principal surface (11a) of the base (11) is inclined toward a vertex (P) of the substantial paraboloid of revolution with respect to a direction orthogonal to an axis (X) of the substantial paraboloid of revolution. Thus, the light-emitting device (1) can be provided in which light distribution control can be facilitated.

### TECHNICAL FIELD

The present invention relates to a light-emitting device including a light-emitting element and an illumination apparatus using the same.

### BACKGROUND ART

Light-emitting elements such as a light-emitting diode (hereinafter, referred to as a “LED”) are used in various types of light-emitting devices. The LED not only has a smaller size and higher efficiency compared with existing light sources that use discharge and radiation but also recently has been advanced to provide increased luminous flux and thus may replace the existing light sources.

Moreover, when combined with an optical system having a reflection function and a lens function, the LED is capable of controlling the radiation pattern of emitted light. For example, JP 2005-32661 A proposes a light-emitting device that allows light emitted from a light-emitting element to be extracted as parallel light using a light-collecting reflector constituted by a partial shape of a paraboloid of revolution.

FIG. 20 shows a schematic perspective view of the light-emitting device proposed in JP 2005-32661 A. Alight-emitting device 100 includes a substrate 101, a light-emitting element 102 that is mounted on the substrate 101, and a light-collecting reflector 103 that is disposed so as to surround the light-emitting element 102. The light-collecting reflector 103 is part of a paraboloid of revolution, and a paraboloid-of-revolution surface 103a that constitutes an inner surface of the light-collecting reflector 103 is a light-reflecting surface for collecting light emitted from the light-emitting element 102. The light-emitting element 102 is disposed at a position of a focal point of the paraboloid-of-revolution surface 103a. According to this configuration, light emitted from the light-emitting element 102 is reflected off the paraboloid-of-revolution surface 103a to become parallel light and is emitted from an opening of the light-collecting reflector 103.

However, in the above-described light-emitting device 100, part of light emitted from an end portion 102a of a light-emitting portion of the light-emitting element 102, which is positioned on the opening side of the light-collecting reflector 103, is not reflected off the paraboloid-of-revolution surface 103a, so that part of the light emitted from the light-emitting element 102 does not become parallel light and thus may hinder light distribution control.

### DISCLOSURE OF INVENTION

In order to solve the above-described problem with the conventional technique, the present invention provides a light-emitting device in which light distribution control can be facilitated.

Alight-emitting device according to the present invention includes: a base; a light source portion that includes a light-emitting portion disposed on one principal surface of the base; and a light distribution control reflector that is disposed so as to surround the light source portion. In the light-emitting device, the light distribution control reflector is at least part of a substantial paraboloid of revolution, and a substantial paraboloid-of-revolution surface that constitutes an inner surface of the light distribution control reflector is a light-reflecting surface for collecting light emitted from the light source portion. Further, a light outgoing portion of the light source portion is disposed at a position of a substantial focal point of the substantial paraboloid-of-revolution surface, and an optical axis of the light source portion is inclined toward a vertex of the substantial paraboloid of revolution with respect to a direction orthogonal to an axis of the substantial paraboloid of revolution.

Furthermore, an illumination apparatus according to the present invention is characterized by using the above-described light-emitting device according to the present invention.

According to the light-emitting device of the present invention, with respect to light emitted from the light-emitting portion, a ratio of part of the light that is not reflected off the inner surface of the light distribution control reflector (substantial paraboloid-of-revolution surface) can be decreased, thereby increasing a ratio of light that is extracted as substantially parallel light. Thus, light distribution control can be facilitated.

### BRIEF DESCRIPTION OF DRAWINGS

FIG. 1A is a schematic perspective view of a light-emitting device according to a first embodiment of the present invention, and FIG. 1B is a schematic cross-sectional view of the light-emitting device shown in FIG. 1A.

FIG. 2 is a schematic perspective view showing a modification example of the light-emitting device according to the first embodiment of the present invention.

FIG. 3A is a schematic perspective view of a light-emitting device according to a second embodiment of the present invention, and FIG. 3B is a schematic cross-sectional view of the light-emitting device shown in FIG. 3A.

FIG. 4 is a schematic cross-sectional view of a light-emitting device according to a third embodiment of the present invention.

FIG. 5A is a schematic cross-sectional view of a light-emitting device according to a fourth embodiment of the present invention, and FIG. 5B is an enlarged schematic cross-sectional view of a light source portion of the light-emitting device shown in FIG. 5A.

FIG. 6A is a schematic cross-sectional view of a light-emitting device according to a fifth embodiment of the present invention, and FIG. 6B is an enlarged schematic cross-sectional view of a light source portion of the light-emitting device shown in FIG. 6A.

FIG. 7A is a schematic cross-sectional view of a light-emitting device according to a sixth embodiment of the present invention, and FIG. 7B is an enlarged schematic cross-sectional view of a light source portion of the light-emitting device shown in FIG. 7A.

FIG. 8A is a schematic cross-sectional view of a light-emitting device according to a seventh embodiment of the present invention, and FIG. 8B is an enlarged schematic cross-sectional view of a light source portion of the light-emitting device shown in FIG. 8A.

FIG. 9 is a schematic cross-sectional view of a light-emitting device according to an eighth embodiment of the present invention.

FIG. 10 is a schematic cross-sectional view of a light-emitting device according to a ninth embodiment of the present invention.

FIG. 11 is a schematic cross-sectional view of a light-emitting device according to a tenth embodiment of the present invention.

FIG. 12 is a schematic cross-sectional view of a light-emitting device according to an eleventh embodiment of the present invention.

FIG. 13 is a schematic cross-sectional view of a light-emitting device according to a twelfth embodiment of the present invention.

FIG. 14 is a schematic cross-sectional view of a light-emitting device according to a thirteenth embodiment of the present invention.

FIG. 15 is a schematic cross-sectional view of a light-emitting device according to a fourteenth embodiment of the present invention.

FIG. 16 is a schematic perspective view of a light-emitting device according to a fifteenth embodiment of the present invention.

FIG. 17 is a schematic perspective view of an illumination apparatus using the light-emitting device according to the present invention.

FIG. 18 is a schematic view for explaining a method of measuring a radiation angle regarding a light-emitting device.

FIG. 19 is a graph showing results of a measurement of a radiation angle regarding a light-emitting device.

FIG. 20 is a schematic perspective view of a conventional light-emitting device.

### DESCRIPTION OF THE INVENTION

The light-emitting device according to the present invention includes: a base; a light source portion that includes a light-emitting portion disposed on one principal surface of the base; and a light distribution control reflector that is disposed so as to surround the light source portion. Further, the light-emitting portion includes a light-emitting element. The light-emitting element is mounted on the one principal surface by, for example, die bonding, wire bonding, flip-chip bonding, face-up chip bonding, eutectic bonding such as of Au—Sn, adhesion bonding such as of Au—Au, pressure bonding using an ACF (anisotropic conductive film) or the like, or bonding with an adhesive such as an Ag paste. The base may be formed so as to be divided into a plurality of units or so as to be stepped.

The material for the base is not particularly limited, and examples thereof that can be used include the following: single crystals such as sapphire, Si, GaN, AlN, ZnO, SiC, BN, and ZnS; ceramics such as Al₂O₃, AlN, BN, MgO, ZnO, and SiC or a mixture thereof, metals such as Al, Cu, Fe, Au, W, and an alloy including any of these metals; resin such as an epoxy resin, silicone resin, acrylic resin, urea resin, amide resin, imide resin, polycarbonate resin, polyphenylene sulfide resin, liquid crystal polymer, acrylonitrile butadiene styrene resin (ABS resin), methacrylic resin (PMMA resin), cyclic olefin copolymer, or a mixture thereof, a laminated material obtained by bonding a metal plate to any of these types of resin; glass; glass epoxy; and muscovite. From the viewpoint of preventing absorption of light, it is desirable that the material for the base be a reflective material that is, for example, a metal such as Al or a laminated material obtained by bonding a metal plate to resin.

The light distribution control reflector is at least part of the substantial paraboloid of revolution, and the substantial paraboloid-of-revolution surface that constitutes the inner surface of the light distribution control reflector is a light-reflecting surface for collecting light emitted from the light source portion. In this specification, the “substantial paraboloid of revolution” and the “substantial paraboloid-of-revolution surface” respectively refer to a paraboloid of revolution and a paraboloid-of-revolution surface not only in their complete forms but also in their modified forms that respectively have the same functions as their complete forms and respectively include even an elliptic paraboloid and an elliptic paraboloid surface.

As for the material for the light-reflecting surface, examples thereof that can be used include the following: metals such as Al, Ag, Au, Ni, Rh, Pd, and an alloy including any of these metals; metallic oxides such as an aluminum oxide, ceric oxide, hafnium oxide, magnesium oxide, niobium oxide, tantalum oxide, zirconium oxide, zinc oxide, titanium oxide, yttrium oxide, silicon oxide, indium oxide, tin oxide, tungsten oxide, and vanadium oxide; and inorganic materials such as silicon nitride, gallium nitride, silicon carbide, calcium fluoride, calcium carbonate, copper sulfide, tin sulfide, zinc sulfide, and barium sulfate or a mixture thereof. When a particulate metallic oxide or inorganic material is used, the average particle size thereof is preferably 0.3 to 3 μm from the viewpoint of the reflection effect due to diffusion and scattering. Further, a distribution Bragg reflecting mirror (thickness: 0.1 to 1 μm) including a multilayer film in which two or more types of these metallic oxides or inorganic materials are stacked alternately also is used effectively for the light reflecting surface. The light distribution control reflector may be formed of any of the above-described examples of the material for the light-reflecting surface or may be formed by forming a substantial paraboloid of revolution using, for example, a resin material or a ceramic material and applying any of the above-described examples of the material for the light-reflecting surface to an inner surface thereof.

The above-described light-reflecting surface may be formed of a prism having a total reflection property. Further, the surface of the light-reflecting surface may be covered with a protective film formed of a translucent material or the like.

The light outgoing portion of the light source portion is disposed at a position of a substantial focal point of the above-described substantial paraboloid-of-revolution surface. In this specification, the “position of a substantial focal point” refers not only to the exact position of a focal point but also to a position in the vicinity of the focal point. According to this configuration, light emitted from the light source portion can be reflected off the above-described substantial paraboloid-of-revolution surface to be extracted as substantial parallel light from the opening of the light distribution control reflector. Further, in this specification, the “substantial parallel light” indicates that emitted light from the opening of the light distribution control reflector has a light distribution angle of 20 degrees or less and preferably 10 degrees or less. The light distribution angle of emitted light can be measured using a light distribution measurement device.

The number of the light source portions is not particularly limited as long as each light source portion can be disposed at a position of a substantial focal point of the above-described paraboloid-of-revolution surface, and could be set appropriately depending on a required light amount.

Examples of a light-emitting element that can be used in the present invention include a red LED for emitting red light at a wavelength of 600 to 660 nm, a yellow LED for emitting yellow light at a wavelength of 550 to 600 nm, a green LED for emitting green light at a wavelength of 500 to 550 nm, a blue LED for emitting blue light at a wavelength of 420 to 500 nm, and a blue-violet LED for emitting blue-violet light at a wavelength of 380 to 420 nm. Further, the light-emitting element may be a LED combined with a phosphor such as a white LED including the blue LED and a yellow phosphor for emitting white light or a white LED including the blue-violet or violet LED and, for example, blue, green and red phosphors for emitting white light. A LED for emitting near infrared light (660 to 780 nm) or infrared light (780 nm to 2 μm) also may be used. As the above-described red and yellow LEDs, for example, LEDs using an AlInGaP material can be used. Further, as the above-described green, blue, blue-violet, and violet LEDs, for example, LEDs using an InGaAlN material can be used. As the LED for emitting red to infrared light, for example, a LED using an AlGaAs or InGaAsP material can be used.

In the light-emitting device according to the present invention, an optical axis of the above-described light source portion is inclined toward a vertex of the above-described substantial paraboloid of revolution with respect to a direction orthogonal to an axis of the above-described substantial paraboloid of revolution. According to this configuration, with respect to light emitted from the light source portion, a ratio of part of the light that is not reflected off the inner surface of the light distribution control reflector (substantial paraboloid-of-revolution surface) can be decreased, thereby increasing a ratio of light that is extracted as substantially parallel light. Thus, according to the light-emitting device of the present invention, light distribution control can be facilitated. In the present invention, in order to increase further the ratio of light that is extracted as substantially parallel light, an angle (acute angle) formed by the above-described optical axis and the above-described substantial paraboloid of revolution is preferably 0 to 60 degrees and more preferably 0 to 45 degrees.

In the light-emitting device according to the present invention, the above-described light-emitting portion further may include a translucent material that covers the above-described light-emitting element. This allows the deterioration of the light-emitting element to be suppressed. As the translucent material, an epoxy resin, silicone resin, acrylic resin or the like can be used. Further, in the case where the light-emitting element in the light-emitting portion is covered with a translucent material, the translucent material may be provided so as to cover the light-emitting element completely without leaving any gap or so as to leave some part of the light-emitting element uncovered to form a hollow structure.

In the light-emitting device according to the present invention, the above-described light-emitting portion further may include a phosphor portion that covers the above-described light-emitting element. This allows light from the light-emitting element and converted light from the phosphor portion to be mixed, so that, for example, white light can be extracted.

The above-described phosphor portion is formed of a translucent material such as, for example, an epoxy resin, silicone resin or acrylic resin and a phosphor dispersed in this translucent material.

As the above-described phosphor, for example, a red phosphor for emitting red light, an orange phosphor for emitting orange light, a yellow phosphor for emitting yellow light, or a green phosphor for emitting green light can be used. As the above-described red phosphor, for example, silicate Ba₃MgSi₂O₈:Eu²⁺, Mn²⁺, nitridosilicate Sr₂Si₅N₈:Eu²⁺, nitridoaluminosilicate CaAlSiN₃:Eu²⁺, oxo-nitridoaluminosilicate Sr₂Si₄AlON₇:Eu²⁺, and sulfide (Sr,Ca)S:Eu²⁺ or La₂O₂S:Eu³⁺, Sm³⁺ can be used. As the above-described orange phosphor, for example, silicate (Sr,Ca)₂SiO₄:Eu²⁺, garnet Gd₅Al₅O₁₂:Ce³⁺, or α-SIALON Ca-α-SiAlON:Eu²⁺ can be used. As the above-described yellow phosphor, for example, silicate (Sr,Ba)₂SiO₄:Eu²⁺ or Sr₃SiO₅:Eu²⁺, garnet (Y,Gd)₃Al₅O₁₂:Ce³⁺, sulfide CaGa₂S₄:Eu²⁺, or α-SIALON Ca-α-SiAlON: Eu²⁺ can be used As the above-described green phosphor, for example, aluminate BaMgAl₁₀O₁₇:Eu²⁺, Mn²⁺ or (Ba,Sr,Ca)Al₂O₄:Eu²⁺, silicate (Ba,Sr)₂SiO₄:Eu²⁺, α-SIALON Ca-α-SiAlON:Yb²⁺, β-SIALON β-Si₃N₄:Eu²⁺, oxo-nitridosilicate (Ba,Sr,Ca)Si₂O₂N₂:Eu²⁺, oxo-nitridoaluminosilicate (Ba,Sr,Ca)₂Si₄AlON₇:Ce³⁺, sulfide SrGa₂S₄:Eu²⁺, garnet Y₃(Al,Ga)₅O₁₂:Ce³⁺, or oxide CaSc₂O₄:Ce³⁺ can be used.

In the case where the blue-violet or ultraviolet LED is used as the light-emitting element, for example, the above-described phosphors could be used with a blue phosphor for emitting blue light or a cyan phosphor for emitting cyan light. As the above-described blue phosphor, for example, aluminate BaMgAl₁₀O₁₇:Eu²⁺, silicate Ba₃MgSi₂O₈:Eu²⁺, or halophosphate (Sr,Ba)₁₀(PO₄)₆Cl₂:Eu²⁺ can be used. As the above-described cyan phosphor, aluminate Sr₄Al₁₄O₂₅:Eu²⁺ or silicate Sr₂Si₃O₈.2SrCl₂:Eu²⁺ can be used.

In the light-emitting device according to the present invention, preferably, the above-described light distribution control reflector is a substantial paraboloid of revolution. In this configuration, the light-emitting portion is surrounded at its periphery (360 degrees in all azimuths) by the light distribution control reflector, and thus a ratio of light that is extracted as substantially parallel light further can be increased.

The light-emitting device according to the present invention further may include an optical path changing portion that changes an optical path of light emitted from the opening of the above-described light distribution control reflector. This further facilitates light distribution control. As the material for the optical path changing portion, a material similar to the material for the above-described light distribution control reflector can be used.

Hereinafter, embodiments of the present invention will be described with reference to the appended drawings. In the drawings referred to, components having substantially the same function are denoted by the same reference character, and a duplicate explanation thereof may be omitted. Further, for the sake of making the drawings easier to understand, a light-emitting element is drawn on an enlarged scale with respect to a light distribution control reflector. Even in this case, each light outgoing portion of a light source portion is disposed at a position of a substantial focal point of a substantial paraboloid-of-revolution surface that constitutes an inner surface of the light distribution control reflector.

### First Embodiment

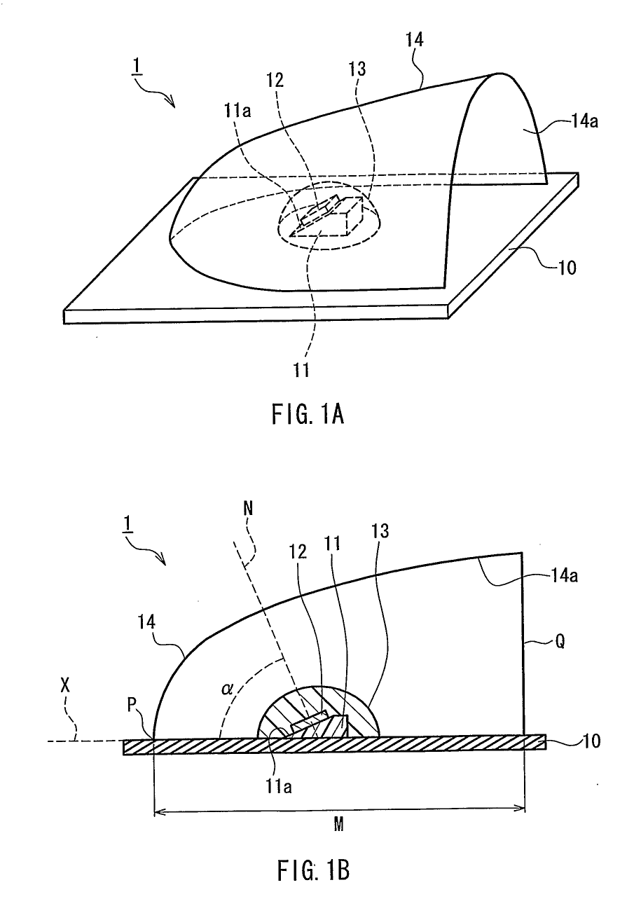

FIG. 1A is a schematic perspective view of a light-emitting device according to a first embodiment of the present invention, and FIG. 1B is a schematic cross-sectional view of the light-emitting device shown in FIG. 1A.

As shown in each of FIGS. 1A and 1B, a light-emitting device 1 includes a substrate 10, a base 11 that is disposed on the substrate 10, a light-emitting element 12 that is disposed on one principal surface 11a of the base 11, a sealing resin portion 13 that is formed of a translucent material and covers the light-emitting element 12, and a light distribution control reflector 14 that is disposed so as to surround the light-emitting element 12 and the sealing resin portion 13. The material for the substrate 10 is not particularly limited, and examples thereof that can be used include the following: single crystals such as sapphire, Si, GaN, AlN, ZnO, SiC, BN, and ZnS; ceramic such as Al₂O₃, AlN, BN, MgO, ZnO, SiC, and C or a mixture thereof; metals such as Al, Cu, Fe, Au, W. and an alloy including any of these metals; resin such as an epoxy resin, silicone resin, acrylic resin, urea resin, amide resin, imide resin, polycarbonate resin, polyphenylene sulfide resin, liquid crystal polymer, acrylonitrile butadiene styrene resin (ABS resin), methacrylic resin (PMMA resin), cyclic olefin copolymer, or a mixture thereof; and a laminated material obtained by bonding a metal plate to any of these types of resin.

The light distribution control reflector 14 is at least part of a substantial paraboloid of revolution, and a substantial paraboloid-of-revolution surface 14a that constitutes an inner surface of the light distribution control reflector 14 is a light-reflecting surface for collecting light emitted from the light-emitting element 12. The light-emitting element 12 is disposed at a position of a substantial focal point of the substantial paraboloid-of-revolution surface 14a. A normal N to the one principal surface 11a of the base 11 that corresponds to an optical axis of the light-emitting element 12 is inclined toward a vertex P of the above-described substantial paraboloid of revolution with respect to a direction orthogonal to an axis X of the above-described substantial paraboloid of revolution. According to this configuration, with respect to light emitted from the light-emitting element 12, a ratio of part of the light that is not reflected off the inner surface 14a of the light distribution control reflector 14 (substantial paraboloid-of-revolution surface) can be decreased, thereby increasing a ratio of light that is extracted as substantially parallel light from an opening Q of the light distribution control reflector 14. Thus, according to the light-emitting device 1, light distribution control can be facilitated.

In this embodiment, a light-emitting portion is composed of the light-emitting element 12 and the sealing resin portion 13, and moreover, a light source portion is composed only of the light-emitting portion. Accordingly, in this embodiment, the optical axis of the light-emitting element 12 corresponds to an optical axis of the light source portion. Further, in this embodiment, a light outgoing portion of the light-emitting element 12 corresponds to a light outgoing portion of the light source portion.

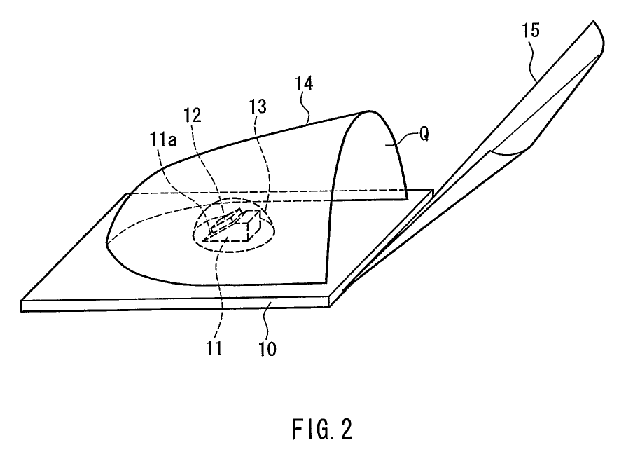

Although the above description has been directed to the light-emitting device 1 according to the first embodiment, the present invention is not limited to the above-described embodiment. For example, as shown in a perspective view in FIG. 2, an optical path changing reflector 15 further may be included as an optical path changing portion that changes an optical path of light emitted from the opening Q of the light distribution control reflector 14. This further facilitates light distribution control. In this case, it is preferable that the substrate 10 and the optical path changing reflector 15 are integrated because this improves a heat dissipation property regarding heat emitted from the light-emitting element 12. In order to further improve the heat dissipation property, a material having a high heat dissipation property such as Al or Ag could be used as the material for the optical path changing reflector 15. Further, in place of the sealing resin portion 13, a phosphor portion that converts light from the light-emitting element 12 may be provided.

As the optical path changing portion, as well as the above-described optical path changing reflector, for example, a reflection plate, a lens, a diffractive lens, a fiber bundle, a half mirror, or a dichroic mirror can be used.

### Second Embodiment

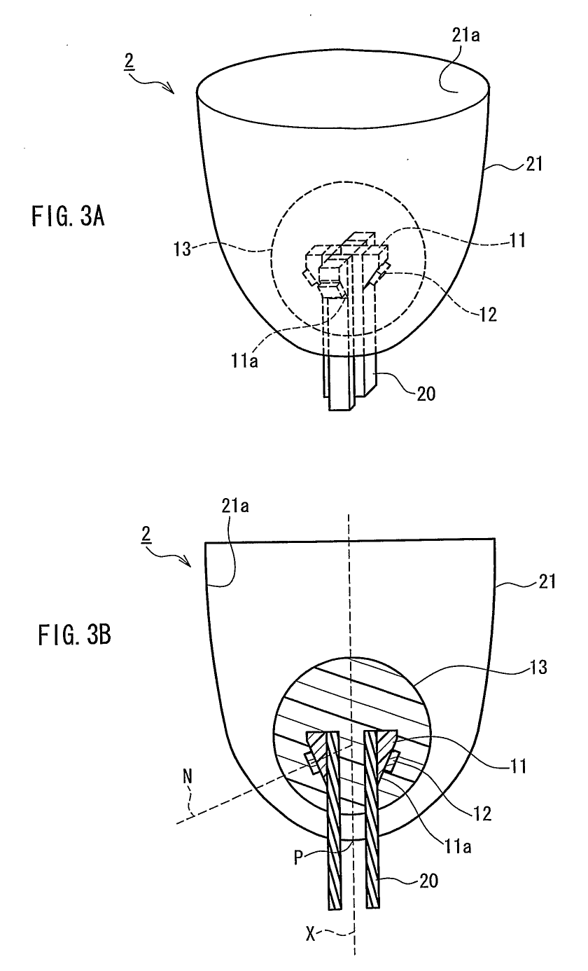

FIG. 3A is a schematic perspective view of a light-emitting device according to a second embodiment of the present invention, and FIG. 3B is a schematic cross-sectional view of the light-emitting device shown in FIG. 3A.

As shown in each of FIGS. 3A and 3B, a light-emitting device 2 includes four column-shaped bodies 20, a base 11 that is disposed at an end portion of each of the column-shaped bodies 20, a light-emitting element 12 that is disposed on one principal surface 11a of the base 11, a spherical sealing resin portion 13 that covers the light-emitting elements 12, and a light distribution control reflector 21 that is disposed so as to surround the light-emitting elements 12 and the sealing resin portion 13. The light distribution control reflector 21 is a substantial paraboloid of revolution having an axis X in a region surrounded by the four column-shaped bodies 20. The material for the column-shaped bodies 20 is not particularly limited, and a material similar to the material for the above-described substrate 10 of the light-emitting device 1 (see FIGS. 1A and 1B) can be used.

In the light distribution control reflector 21, a substantial paraboloid-of-revolution surface 21a that constitutes an inner surface of the light distribution control reflector 21 is a light-reflecting surface for collecting light emitted from the light-emitting elements 12. The light-emitting elements 12 are disposed at positions of substantial focal points of the substantial paraboloid-of-revolution surface 21a, respectively. A normal N to the one principal surface 11a of each of the bases 11 is inclined toward a vertex P of the light distribution control reflector 21 (substantial paraboloid of revolution) with respect to a direction orthogonal to the axis X of the light distribution control reflector 21 (substantial paraboloid of revolution). According to this configuration, with respect to light emitted from the light-emitting elements 12, a ratio of part of the light that is not reflected off an inner surface 21a (substantial paraboloid-of-revolution surface) of the light distribution control reflector 21 can be decreased, thereby increasing a ratio of light that is extracted as substantially parallel light. Thus, according to the light-emitting device 2, light distribution control can be facilitated. Further, in the light-emitting device 2, the light-emitting elements 12 are surrounded at their peripheries (360 degrees in all azimuths) by the light distribution control reflector 21, and thus the ratio of light that is extracted as substantially parallel light can be increased more than in the light-emitting device 1 of the first embodiment.

In this embodiment, a light-emitting portion is composed of the light-emitting elements 12 and the sealing resin portion 13, and moreover, a light source portion is composed only of the light-emitting portion. Accordingly, in this embodiment, an optical axis of each of the light-emitting elements 12 corresponds to an optical axis of the light source portion. Further, in this embodiment, a light outgoing portion of each of the light-emitting elements 12 corresponds to a light outgoing portion of the light source portion.

### Third Embodiment

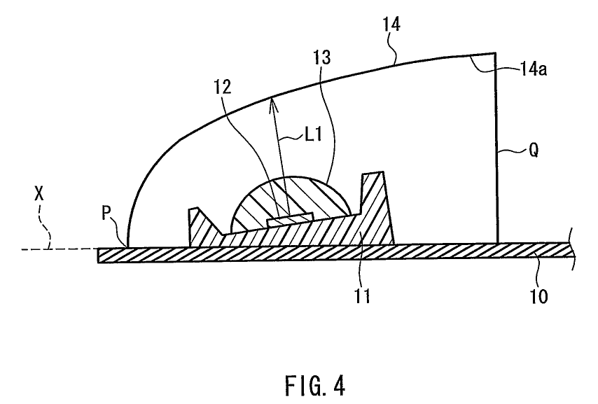

FIG. 4 is a schematic cross-sectional view of a light-emitting device according to a third embodiment of the present invention. The light-emitting device of this embodiment is a modification example of the first embodiment.

As shown in FIG. 4, a light-emitting element 12 is disposed at a position of a substantial focal point of a substantial paraboloid-of-revolution surface 14a, and a base 11 functions also as a reflection plate. Further, an upper surface of the base 11 is inclined with respect to an X axis of a substantial paraboloid of revolution so that an optical axis L1 of the light-emitting element 12 (optical axis of a light-emitting portion) is inclined toward a vertex P of the substantial paraboloid of revolution with respect to a direction orthogonal to the axis X of the substantial paraboloid of revolution. Thus, similarly to the light-emitting device 1 of the first embodiment, light distribution control can be facilitated.

In this embodiment, the light-emitting portion is composed of the light-emitting element 12 and a sealing resin portion 13, and moreover, a light source portion is composed only of the light-emitting portion. Accordingly, in this embodiment, then the optical axis of the light-emitting element 12 corresponds to the optical axis of the light source portion. Further, in this embodiment, a light outgoing portion of the light-emitting element 12 corresponds to a light outgoing portion of the light source portion.

### Fourth Embodiment

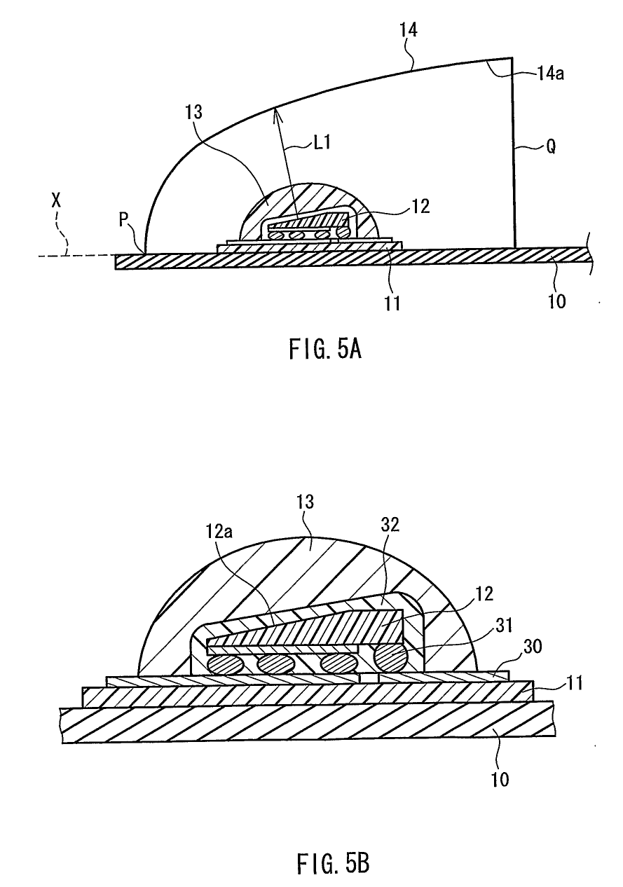

FIG. 5A is a schematic cross-sectional view of a light-emitting device according to a fourth embodiment of the present invention, and FIG. 5B is an enlarged schematic cross-sectional view of a light source portion of the light-emitting device shown in FIG. 5A.

As shown in FIG. 5B, a light-emitting element 12 is connected electrically via a bump 31 to a wiring 30 formed on a base 11. Further, the light-emitting element 12 is covered with a phosphor portion 32 and further is covered with a sealing resin portion 13. The bump 31 can be formed of a metal such as gold.

Furthermore, as shown in each of FIGS. 5A and 5B, the light-emitting element 12 is disposed at a position of a substantial focal point of a substantial paraboloid-of-revolution surface 14a, and an upper surface 12a of the light-emitting element 12 is inclined with respect to an X axis of a substantial paraboloid of revolution so that an optical axis L1 of the light-emitting element 12 (optical axis of a light-emitting portion) is inclined toward a vertex P of the substantial paraboloid of revolution with respect to a direction orthogonal to the axis X of the substantial paraboloid of revolution. Thus, similarly to the light-emitting device 1 of the first embodiment, light distribution control can be facilitated.

In FIG. 5A, for the sake of easy viewing of the drawing, hatching that is used to show a cross section is partially omitted. Similarly in cross-sectional views referred to in the following description, hatching that is used to show a cross section may be partially omitted.

In this embodiment, the light-emitting portion is composed of the light-emitting element 12 and the sealing resin portion 13, and moreover, a light source portion is composed only of the light-emitting portion. Accordingly, in this embodiment, the optical axis of the light-emitting element 12 corresponds to an optical axis of the light source portion. Further, in this embodiment, a light outgoing portion of the light-emitting portion 12 corresponds to a light outgoing portion of the light source portion.

### Fifth Embodiment

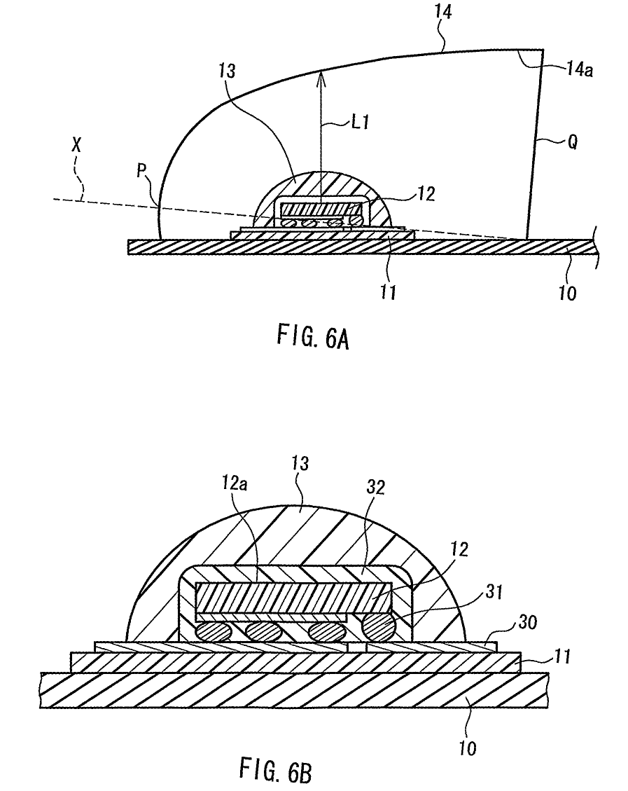

FIG. 6A is a schematic cross-sectional view of a light-emitting device according to a fifth embodiment of the present invention, and FIG. 6B is an enlarged schematic cross-sectional view of a light source portion of the light-emitting device shown in FIG. 6A.

As shown in each of FIGS. 6A and 6B, this embodiment has a similar configuration to that of the fourth embodiment except that, instead of an upper surface 12a of a light-emitting element 12 being inclined with respect to a substrate 10, the substrate 10 is inclined with respect to an X axis of a substantial paraboloid of revolution so that an optical axis L1 of the light-emitting element 12 (optical axis of a light-emitting portion) is inclined toward a vertex P of the substantial paraboloid of revolution with respect to a direction orthogonal to the axis X of the substantial paraboloid of revolution. Thus, similarly to the light-emitting device 1 of the first embodiment, light distribution control can be facilitated.

### Sixth Embodiment

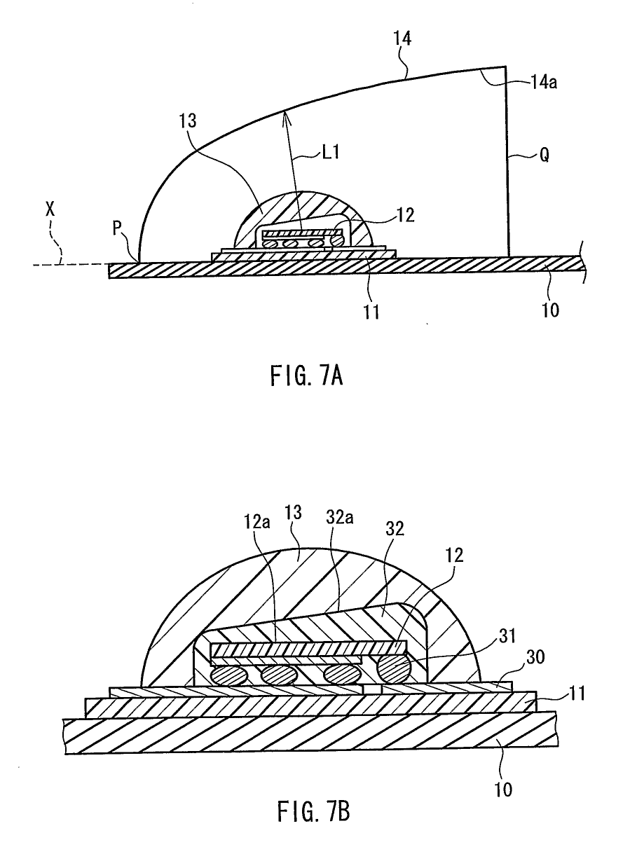

FIG. 7A is a schematic cross-sectional view of a light-emitting device according to a sixth embodiment of the present invention, and FIG. 7B is an enlarged schematic cross-sectional view of a light source portion of the light-emitting device shown in FIG. 7A.

As shown in each of FIGS. 7A and 7B, this embodiment has a similar configuration to that of the fourth embodiment except that, instead of an upper surface 12a of a light-emitting element 12 being inclined with respect to a substrate 10, an upper surface 32a of a phosphor portion 32 is inclined with respect to an X axis of a substantial paraboloid of revolution so that an optical axis L1 of the light-emitting element 12 (optical axis of a light-emitting portion) is inclined toward a vertex P of the substantial paraboloid of revolution with respect to a direction orthogonal to the axis X of the substantial paraboloid of revolution. Thus, similarly to the light-emitting device 1 of the first embodiment, light distribution control can be facilitated.

### Seventh Embodiment

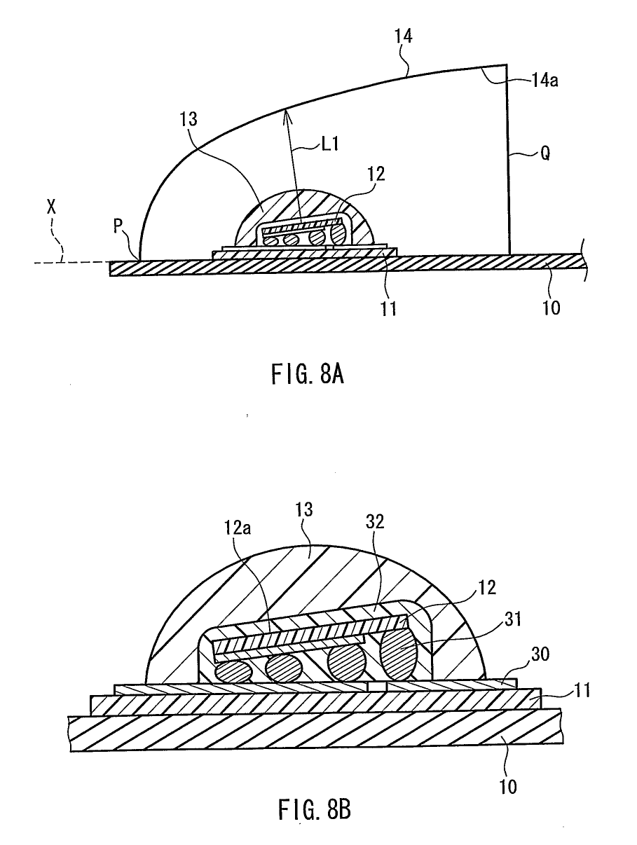

FIG. 8A is a schematic cross-sectional view of a light-emitting device according to a seventh embodiment of the present invention, and FIG. 8B is an enlarged schematic cross-sectional view of a light source portion of the light-emitting device shown in FIG. 8A.

As shown in each of FIGS. 8A and 8B, this embodiment has a similar configuration to that of the fourth embodiment except that, instead of part of an upper surface 12a of a light-emitting element 12 being inclined with respect to a substrate 10, the light-emitting element 12 is inclined by adjusting a height of a bump 31 for the light-emitting element 12 so that an optical axis L1 of the light-emitting element 12 (optical axis of a light-emitting portion) is inclined toward a vertex P of a substantial paraboloid of revolution with respect to a direction orthogonal to an axis X of the substantial paraboloid of revolution. Thus, similarly to the light-emitting device 1 of the first embodiment, light distribution control can be facilitated.

### Eighth Embodiment

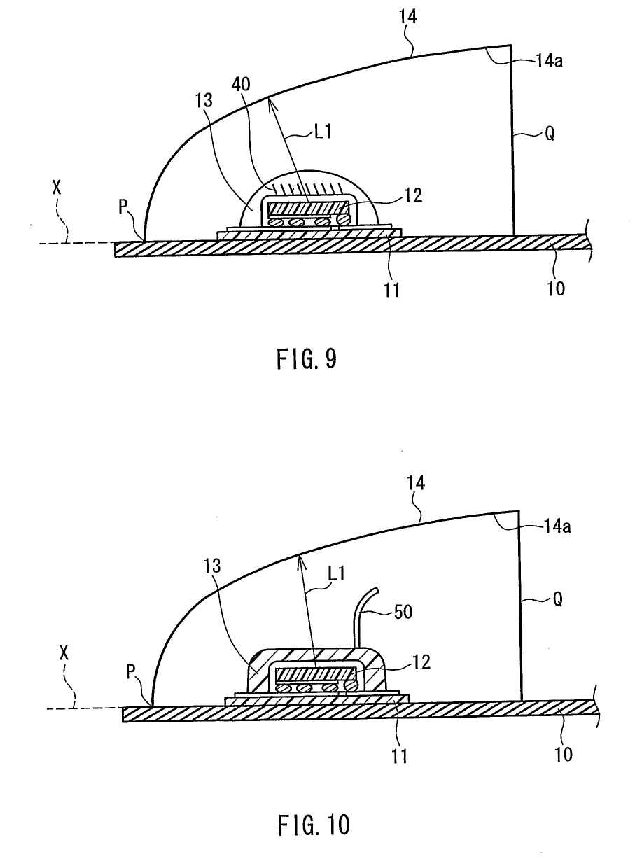

FIG. 9 is a schematic cross-sectional view of a light-emitting device according to an eighth embodiment of the present invention.

In this embodiment, as shown in FIG. 9, a light-emitting element 12 is disposed at a position of a substantial focal point of a substantial paraboloid-of-revolution surface 14a, and a plurality of fins 40 are disposed as an optical path changing portion inside a sealing resin portion 13. As shown in FIG. 9, the fins 40 are disposed inside the sealing resin portion 13 in such a manner as to be inclined toward a vertex P of a substantial paraboloid of revolution, and thus an optical axis L1 of the light-emitting element 12 (optical axis of a light-emitting portion) can be inclined toward the vertex P of the substantial paraboloid of revolution with respect to a direction orthogonal to an axis X of the substantial paraboloid of revolution. Thus, similarly to the light-emitting device 1 of the first embodiment, light distribution control can be facilitated.

In this embodiment, the light-emitting portion is composed of the light-emitting element 12 and the sealing resin portion 13, and moreover, a light source portion is composed only of the light-emitting portion. Accordingly, in this embodiment, the optical axis of the light-emitting element 12 corresponds to an optical axis of the light source portion. Further, in this embodiment, a light outgoing portion of the light-emitting element 12 corresponds to a light outgoing portion of the light source portion.

The fins 40 may be formed of, for example, a metal itself such as Al. Alternatively, the fins 40 may be formed of resin or an inorganic material with a surface on which Al, Ag or the like is vapor-deposited or a dielectric film is formed.

### Ninth Embodiment

FIG. 10 is a schematic cross-sectional view of a light-emitting device according to a ninth embodiment of the present invention.

In this embodiment, as shown in FIG. 10, a light-emitting element 12 is disposed at a position of a substantial focal point of a substantial paraboloid-of-revolution surface 14a, and a reflection plate 50 is disposed as an optical path changing portion on an outer surface of a light-emitting portion. As shown in FIG. 10, the reflection plate 50 is disposed on the outer surface of the light-emitting portion, and thus an optical axis L1 of the light-emitting element 12 (optical axis of the light-emitting portion) can be inclined toward a vertex P of a substantial paraboloid of revolution with respect to a direction orthogonal to an axis X of the substantial paraboloid of revolution. Thus, similarly to the light-emitting device 1 of the first embodiment, light distribution control can be facilitated.

In this embodiment, the light-emitting portion is composed of the light-emitting element 12, a sealing resin portion 13 and the reflection plate 50, and moreover, a light source portion is composed only of the light-emitting portion. Accordingly, in this embodiment, the optical axis of the light-emitting element 12 corresponds to an optical axis of the light source portion. Further, in this embodiment, a light outgoing portion of the light-emitting element 12 corresponds to a light outgoing portion of the light source portion.

As the above-described optical path changing portion, as well as a reflection plate, for example, a lens, a grating or the like can be used.

### Tenth Embodiment

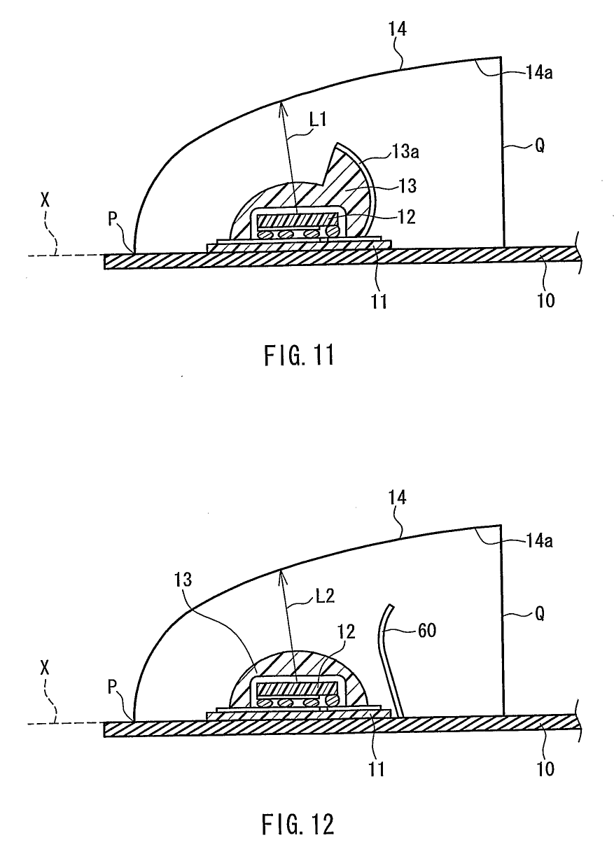

FIG. 11 is a schematic cross-sectional view of a light-emitting device according to a tenth embodiment of the present invention.

In this embodiment, as shown in FIG. 11, a light-emitting element 12 is disposed at a position of a substantial focal point of a substantial paraboloid-of-revolution surface 14a. Further, as an optical path changing portion, a sealing resin portion 13 is formed in the shape of a lens, and a reflective film 13a is provided on one side of the sealing resin portion 13. As shown in FIG. 11, the sealing resin portion 13 is formed in the shape of a lens, and the reflective film 13a is provided on the one side of the sealing resin portion 13, and thus an optical axis L1 of the light-emitting element 12 (optical axis of a light-emitting portion) can be inclined toward a vertex P of a substantial paraboloid of revolution with respect to a direction orthogonal to an axis X of the substantial paraboloid of revolution. Thus, similarly to the light-emitting device 1 of the first embodiment, light distribution control can be facilitated.

In this embodiment, the light-emitting portion is composed of the light-emitting element 12 and the sealing resin portion 13, and moreover, a light source portion is composed only of the light-emitting portion. Accordingly, in this embodiment, the optical axis of the light-emitting element 12 corresponds to an optical axis of the light source portion. Further, in this embodiment, a light outgoing portion of the light-emitting element 12 corresponds to a light outgoing portion of the light source portion.

The reflective film 13a can be formed of a vapor-deposited film or a dielectric film on which Al, Ag or the like is vapor-deposited.

### Eleventh Embodiment

FIG. 12 is a schematic cross-sectional view of a light-emitting device according to an eleventh embodiment of the present invention.

In this embodiment, as shown in FIG. 12, a light emitting element 12 is disposed at a position of a substantial focal point of a substantial paraboloid-of-revolution surface 14a, and a reflection plate 60 is disposed as an optical path changing portion in the vicinity of a light-emitting portion. As shown in FIG. 12, the reflection plate 60 is disposed in the vicinity of the light-emitting portion so that an optical axis L2 of the light-emitting element 12 (optical axis of a light source portion) is inclined toward a vertex P of a substantial paraboloid of revolution with respect to a direction orthogonal to an axis X of the substantial paraboloid of revolution. Thus, similarly to the light-emitting device 1 of the first embodiment, light distribution control can be facilitated.

In this embodiment, the light-emitting portion is composed of the light-emitting element 12 and a sealing resin portion 13, and moreover, a light source portion is composed of the light-emitting portion and the reflection plate 60. Accordingly, in this embodiment, the optical axis of the light-emitting element 12 corresponds to an optical axis of the light source portion. Further, in this embodiment, a light outgoing portion of the light-emitting element 12 corresponds to a light outgoing portion of the light source portion.

As the above-described optical path changing portion, as well as a reflection plate, for example, a lens, a grating or the like can be used.

### Twelfth Example

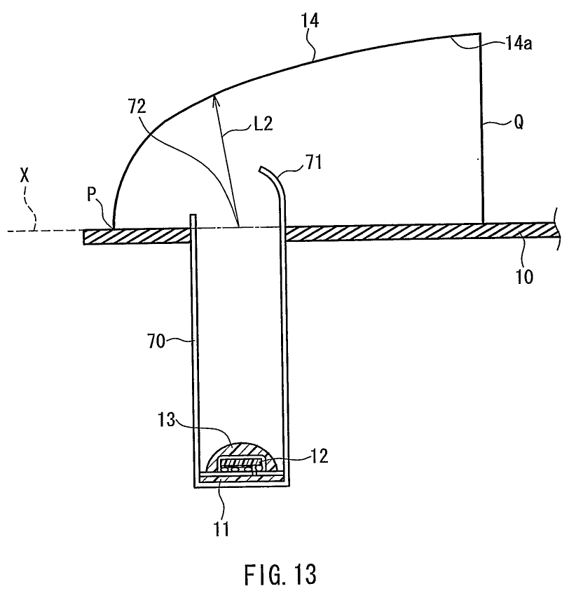

FIG. 13 is a schematic cross-sectional view of a light-emitting device according to a twelfth embodiment of the present invention.

In this embodiment, as shown in FIG. 13, a light-emitting element 12 is disposed at a bottom of an optical path changing portion composed of a cylindrical guide 70 and a reflection plate 71, and a light outgoing portion 72 of a light source portion is disposed at a position of a substantial focal point of a substantial paraboloid-of-revolution surface 14a. As shown in FIG. 13, the optical path changing portion composed of the cylindrical guide 70 and the reflection plate 71 is provided, and thus an optical axis L2 of the light source portion can be inclined toward a vertex P of a substantial paraboloid of revolution with respect to a direction orthogonal to an axis X of the substantial paraboloid of revolution. Thus, similarly to the light-emitting device 1 of the first embodiment, light distribution control can be facilitated.

In this embodiment, a light-emitting portion is composed of the light-emitting element 12 and a sealing resin portion 13, and moreover, the light source portion is composed of the light-emitting portion, the cylindrical guide 70 and the reflection plate 71.

The cylindrical guide 70 and the reflection plate 71 could be formed of a material similar to the material for the above-described light distribution control reflector 14.

### Thirteenth Embodiment

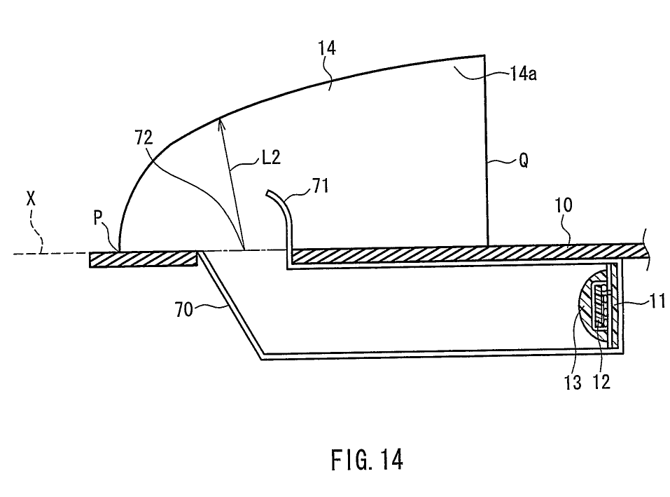

FIG. 14 is a schematic cross-sectional view of a light-emitting device according to a thirteenth embodiment of the present invention. This embodiment has a similar configuration to that of the twelfth embodiment except that a cylindrical guide 70 is bent and inclined.

### Fourteenth Embodiment

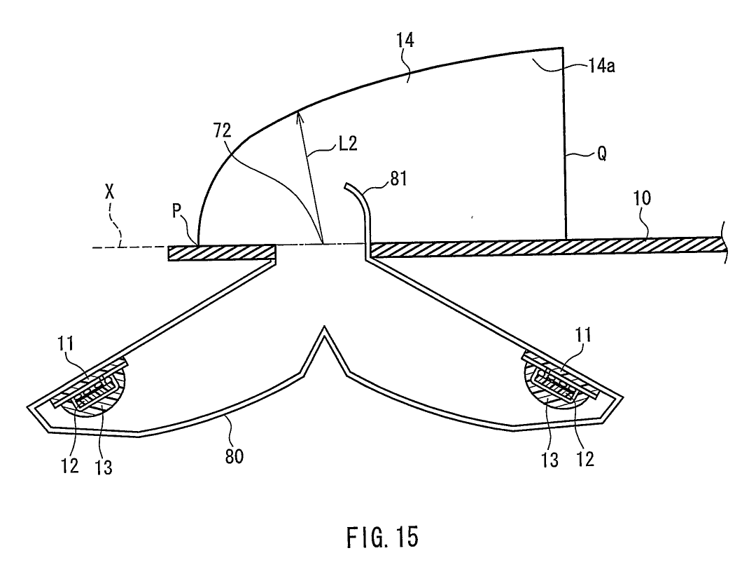

FIG. 15 is a schematic cross-sectional view of a light-emitting device according to a fourteenth embodiment of the present invention.

In this embodiment, as shown in FIG. 15, a plurality of light-emitting elements 12 are disposed on an outer peripheral side of an optical path changing portion including a light-collecting reflector 80 that is a substantial ellipsoid of revolution and a reflection plate 81, and a light outgoing portion 72 of a light source portion is disposed at a position of a substantial focal point of a substantial paraboloid-of-revolution surface 14a. As shown in FIG. 15, the optical path changing portion having the above-described configuration is provided, and thus an optical axis L2 of the light-emitting elements 12 (optical axis of the light source portion) can be inclined toward a vertex P of a substantial paraboloid of revolution with respect to a direction orthogonal to an axis X of the substantial paraboloid of revolution. Thus, similarly to the light-emitting device 1 of the first embodiment, light distribution control can be facilitated.

In this embodiment, a light-emitting portion is composed of the light-emitting elements 12 and sealing resin portions 13, and moreover, the light source portion is composed of the light-emitting portion, the light-collecting reflector 80 and the reflection plate 81.

The light-collecting reflector 80 and the reflection plate 81 may be formed of a material similar to the material for the above-described light distribution control reflector 14.

### Fifteenth Embodiment

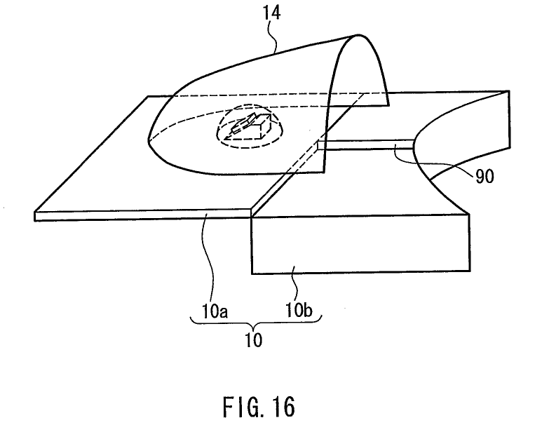

FIG. 16 is a schematic perspective view of a light-emitting device according to a fifteenth embodiment of the present invention.

As shown in FIG. 16, this embodiment has a similar configuration to that of the first embodiment except that a substrate 10 is divided into a substrate 10a and a substrate lob, and a step height 90 is formed at part of the substrate lob. By the provision of the step height 90, in the case where the light-emitting device of this embodiment is used as, for example, a light-emitting device for an automotive headlight, a cut-off line can be formed in a light distribution pattern. That is, generally, an automotive headlight is required to have a light distribution pattern such that light irradiated onto a vertical plane in front of the headlight spreads in a horizontal direction, and there is a boundary at a certain height that clearly separates a bright portion from a dark portion. This boundary between the bright portion and the dark portion is referred to as a cut-off line, and for reasons such as avoiding discomfort to an oncoming driver, the height at which the boundary is formed is set so as to be somewhat lower on an oncoming car side relative to a center portion compared with the height on an own car side. Thus, according to an automotive headlight using the light-emitting device of this embodiment, a cut-off line can be formed, and the same level of safety as that achieved by a conventional automotive headlight can be secured.

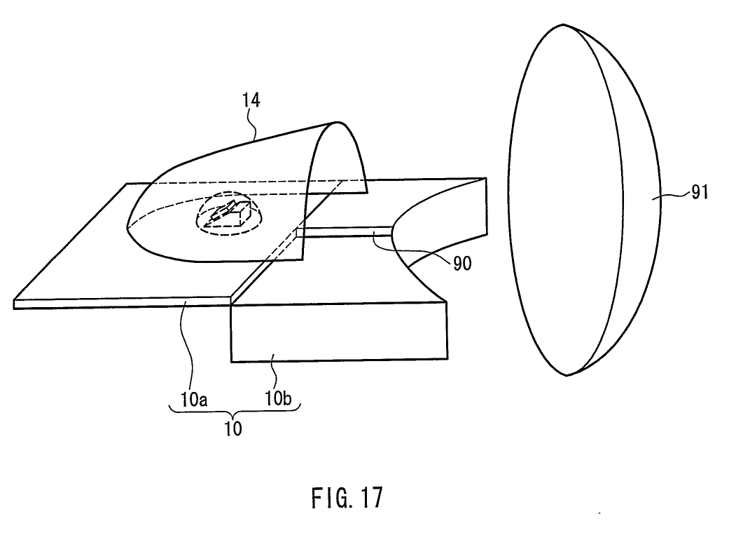

In order to form an illumination apparatus such as the above-described automotive headlight or the like using the light-emitting device of this embodiment, as shown in FIG. 17, the light-emitting device of this embodiment and a lens 91 could be used in combination.

Hereinafter, the present invention will be described by way of examples. The present invention, however, is not limited to these examples.

### (Manufacturing of a Light-Emitting Device)

As examples of the present invention, samples of the light-emitting device shown in each of FIGS. 1A and 1B were prepared. A GaN-based LED chip (thickness: 0.1 mm, 0.35 mm square) using a n-GaN substrate was used for the light-emitting element 12. A silicone resin was used for the sealing resin portion 13 with which the light-emitting element 12 was sealed. As the light distribution control reflector 14, part of a substantial paraboloid of revolution obtained by rotation of a parabola such that Y²=20X on an X axis shown in FIG. 1B was used, and Ag was used as a material for an inner surface thereof. Further, in the above-described substantial paraboloid of revolution, a length M between the vertex P and the opening Q was set to 4 cm. As the examples, the samples were manufactured so that they had an angle inclination angle) α, which was formed by the normal N to the one principal surface 11a of the base 11 and the axis X of the above-described substantial paraboloid of revolution, of 0 degrees, 30 degrees, 45 degrees and 60 degrees, respectively. Further, as a comparative example, a sample of the light-emitting device similar to the above-described examples except that the above-described inclination angle α was set to 90 degrees.

### (Method of Measuring a Radiation Angle)

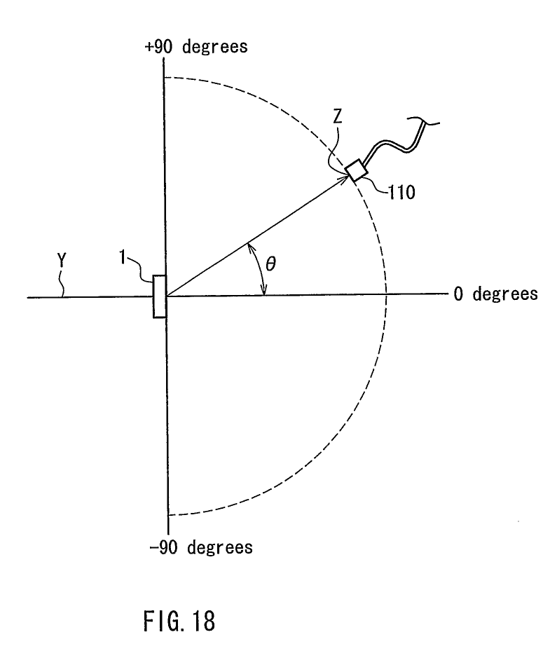

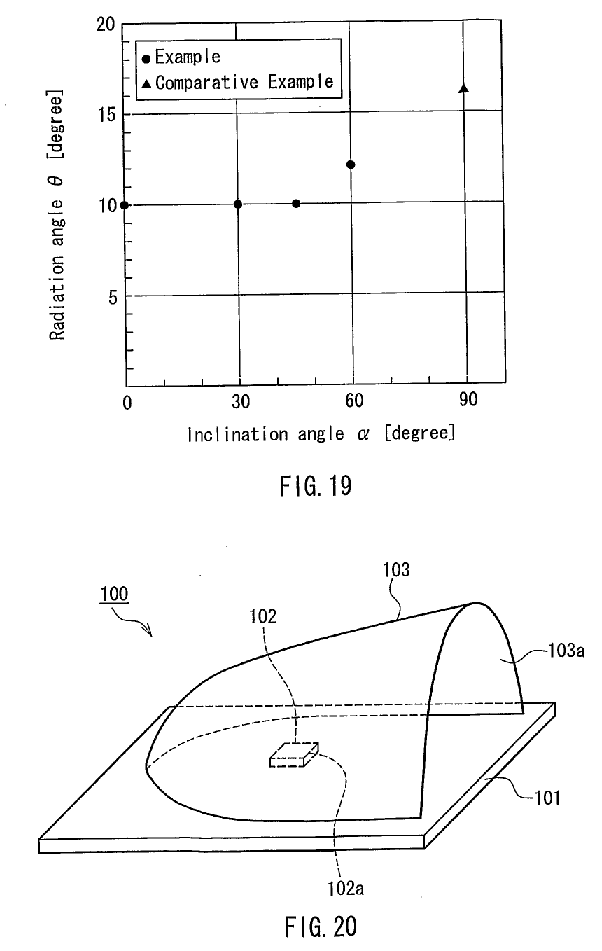

In order to evaluate a light distribution property of each of the manufactured samples of the light-emitting device, a radiation angle of emitted light was measured. The following describes a method of the measurement with reference to FIG. 18. FIG. 18 is a schematic view for explaining a method of measuring a radiation angle regarding the light-emitting device. While the light-emitting device 1 is allowed to emit light, the intensity of emitted light that passes over a semicircle (represented by a broken line in FIG. 18) having a radius of 1 m with the light-emitting device 1 being the center was measured using a detector 110 (main body: an instant multiple photometry system MCPD-3000 manufactured by Otsuka Electronics Co., Ltd.). Assuming that an emitted light intensity at a point where an optical axis Y of the light-emitting device 1 intersects with the above-described semicircle is 100%, a radiation angle θ at a point Z where the emitted light intensity is 50% was plotted in FIG. 19.

As shown in FIG. 19, according to the examples of the present invention, values of the radiation angle θ could be controlled so as to be uniform with respect to the comparative example. This has revealed that the present invention allows light distribution control to be facilitated.

The present invention can be carried out in embodiments other than the above-described embodiments within a scope not departing from the spirit of the present invention. The embodiments disclosed in the present application are described merely for an illustrative purpose, and the present invention is not limited thereto. The scope of the present invention is to be interpreted by placing priority on the attached claims, rather than the above description in the specification, and all the changes within the scope equivalent to that of the claims are included in the claims.

### INDUSTRIAL APPLICABILITY

The light-emitting device of the present invention is useful in, for example, an illumination apparatus used for general illumination, illumination for performance (spotlight, a sign lamp or the like), illumination for automobiles (in particular, a headlight) or the like, and a display apparatus used in a display, a projector or the like. Furthermore, the light-emitting device of the present invention also is useful as a light source for a sensor requiring miniaturization and a thickness reduction.

1. A light-emitting device, comprising:
a base;
a light source portion that includes a light-emitting portion disposed on one principal surface of the base; and
a light distribution control reflector that is disposed so as to surround the light source portion,
wherein the light distribution control reflector is at least part of a substantial paraboloid of revolution, and a substantial paraboloid-of-revolution surface that constitutes an inner surface of the light distribution control reflector is a light-reflecting surface for collecting light emitted from the light source portion,
a light outgoing portion of the light source portion is disposed at a position of a substantial focal point of the substantial paraboloid-of-revolution surface, and
an optical axis of the light source portion is inclined toward a vertex of the substantial paraboloid of revolution with respect to a direction orthogonal to an axis of the substantial paraboloid of revolution.

2. The light-emitting device according to claim 1,
wherein the light-emitting portion comprises a light-emitting element.

3. The light-emitting device according to claim 2,
wherein the light-emitting portion further comprises a translucent material that covers the light-emitting element.

4. The light-emitting device according to claim 2,
wherein the light-emitting portion further comprises a phosphor portion that covers the light-emitting element.

5. The light-emitting device according to claim 1,
wherein a normal to the one principal surface of the base is inclined toward the vertex of the substantial paraboloid of revolution with respect to the direction orthogonal to the axis of the substantial paraboloid of revolution.

6. The light-emitting device according to claim 1,
wherein an optical axis of the light-emitting portion is inclined toward the vertex of the substantial paraboloid of revolution with respect to the direction orthogonal to the axis of the substantial paraboloid of revolution.

7. The light-emitting device according to claim 1,
wherein the light-emitting portion further comprises an optical path changing portion, and an optical axis of the light-emitting portion is inclined toward the vertex of the substantial paraboloid of revolution with respect to the direction orthogonal to the axis of the substantial paraboloid of revolution.

8. The light-emitting device according to claim 1,
wherein the light source portion further comprises an optical path changing portion.

9. The light-emitting device according to claim 1,
wherein the light distribution control reflector is the substantial paraboloid of revolution.

10. The light-emitting device according to claim 1, further comprising an optical path changing portion that changes an optical path of light emitted from an opening of the light distribution control reflector.

11. An illumination apparatus comprising a light-emitting device as claimed in claim 1.
